(19) United States
(12) Patent Application Publication
(10) Pub. No.: US 2013/0027904 A1
(43) Pub. Date: Jan. 31, 2013

(54) LED Lighting Device

(71) Applicant: Chenjun Fan, Ottawa (CA)

(72) Inventor: Chenjun Fan, Ottawa (CA)

(73) Assignee: Chenjun Fan, Ottawa (CA)

(21) Appl. No.: 13/552,784

(22) Filed: Jul. 19, 2012

Related U.S. Application Data
(60) Provisional application No. 61/513,241, filed on Jul. 29, 2011.

(51) Int. Cl. F21V 29/00; F21V 9/16; F21V 11/00

(52) U.S. Cl. 362/84; 362/235; 362/231

(57) ABSTRACT

A solid-state light emitting diode (LED) lighting device is disclosed for use in general lighting. In the preferred embodiment, the LED lighting device comprises a heat sink, a light dome, a light divider, a light distribution plate, and an output globe. A plurality of diffusively reflective compartments are formed inside the output globe for effective light scrambling. The light distribution plate, together with a shaped heat sink and a substantially transparent matching output globe, further enhances omni-directional lighting distribution and luminous efficacy. In some preferred embodiments, color mixing or remote wavelength conversion luminescent phosphor particles are utilized for improved color reproduction. The LED lighting device has high luminous efficacy, indirect glare-free surface illumination, omni-directional distribution, and good color reproduction.

### CROSS-REFERENCE TO RELATED APPLICATIONS

This application claims priority of U.S. Provisional Patent Application No. 61/513,241 filed on Jul. 29, 2011, entitled “LED Lighting Device” which is incorporated herein by reference for all purposes.

### FIELD OF THE INVENTION

This invention generally relates to solid-state lighting devices, as well as related components, systems and methods, and more particularly to methods to make a warm white LED light bulb with high luminous efficacy, omni-directional distribution, and high color rendering.

### BACKGROUND OF THE INVENTION

Because solid-state semiconductor light emitters are environmentally friendly and have a big potential in energy saving and long operation life in comparison with traditional lighting devices, solid-state light emitting apparatus are being widely designed and marketed as replacements for conventional incandescent lighting apparatus. There have been considerable efforts to replace incandescent light bulb using solid-state LEDs. However, most of the existing LED light bulbs suffer at least one of the following shortcomings:

The LEDs are usually mounted on a PCB board that resides in an enclosure inside the bulb. There is a relatively long path for the heat to reach the outer surface of the heat sink. As a result, the thermal resistance is so high as to cause high junction temperature in LEDs. Running an LED at elevated temperatures reduces its emission efficiency and its operation life due to degradation and premature failures.

Solid-state warm white light device with high color rendering index (CRI) is usually realized by using multiple phosphors in combination with blue LEDs, although near-UV LEDs are sometimes used as well. The phosphors are commonly embedded directly in the packaging material or coated directly on the packaging material around the LED chips. As a result, the phosphors are usually subject to relatively high temperatures. It is a well-known fact that phosphor's quantum efficiency decreases as the temperature rises. It is thus desirable that the phosphors are used remotely from the LED chips. While remote phosphor can enhance luminous efficacy, most of the existing LED light bulbs have the phosphors embedded in a plastic enclosure material or have the phosphors coated on a plastic enclosure surfaces. The enclosure scatters a large amount of converted light back into the enclosed cavity. A considerable amount of the converted light is eventually lost to absorption. Moreover, most existing LED light bulbs have multi-phosphor self-absorption issues that cause loss of photons excited from the green and orange phosphor particles. In some existing LED light bulbs, luminous efficacy is further reduced by visible to unwanted near-infrared conversion, as well as by the Stokes Shift loss, a loss from blue to red wavelength conversion.

Solid-state light emitting diodes (LEDs) known in the art extract the light in a forward direction. Although they can have a far field distribution as wide as up to 180 degrees, most general lighting applications require near omni-directional (more than 300 degrees) light distribution. Most existing LED light bulb can only manage to deliver a light distribution of about 180 degrees. Moreover, most of the existing LED light bulbs do not have a shape and form factor that closely matches consumer preference for an incandescent light bulb's look and feel. As a result, the expectation of the consumers remains unmet.

To facilitate better thermal management and combat issues like glare and multiple source shadow, most existing LED light bulbs use a relatively large number of LEDs that have a relatively smaller chip size and are run at relatively lower current. This approach makes the LED light bulb relatively bulky, and increases both material cost and manufacturing cost.

There is a need for an improved LED light bulb that delivers omni-directional distribution with high luminous efficacy, good color reproduction, indirect glare-free surface illumination, and reduced cost.

### SUMMARY OF THE INVENTION

This need is met by the present new, useful, and non-obvious invention.

The LED lighting device of the present invention comprises an electrical connector, an electrical AC/DC conversion and control driver, a heat sink, a plurality of semiconductor light emitting diodes (LEDs), a light dome, a light divider, a light distribution plate, and an output globe. The light dome, the light divider and the light distribution plate form a plurality of diffusively reflective compartments for effective light scrambling before the light exits the highly efficient output globe. The light distribution plate, together with a shaped output globe and a matching heat sink, further enhances omni-directional lighting distribution.

While various shapes of the lighting devices are within the scope of the present invention, the preferred embodiment of the present invention has a shape and form factor closely resembling that of the incandescent light bulb. In a particular preferred embodiment, the combined shape of the heat sink and the output globe forms a standard A19 light bulb shape.

The electrical power connector of the lighting device may be a standard Edison-type screw connector such that the lighting device can be used to replace a standard incandescent light bulb.

The LED typically consists of a light-emitting element called the LED die or LED chip, a chip carrier called the sub-mount, electrical leads, and a lens. The sub-mount is usually thermally conductive but electrically non-conductive. More than one LED chip can be packaged into the same sub-mount as well. The LEDs are commercially available from a number of manufacturers, such as Cree, Philips Lumileds, and Osram. The LEDs without a lens can be used as well. These producers also supply LEDs with or without phosphors included in the package. In the present invention, the LEDs can be distributed and directly attached to the interior surface of the heat sink by means such as soldering. As a result, a very short thermal path to the outer surface of the heat sink and low thermal resistance are achieved. The LED lighting device of the present invention may utilize a few groups of LEDs to achieve desired color rendering index (CRI) in some embodiments, with each group of LEDs emitting a different dominant color.

The disclosed apparatus may use a variety of different structures or arrangements for the light scrambling compartments formed by the light dome, the light divider and the output globe. The preferred embodiment of the present invention has three light scrambling compartments. It is desirable that the interior compartment surfaces have a highly efficient diffusively reflective characteristic, e.g. a reflectivity of over 95%, with respect to the relevant wavelengths, in order to maximize the optical efficiency. For example, the compartments can be formed of a diffusively reflective plastic material, such as MC-PET from Furukawa Electric of Japan, having a 98% reflectivity and a diffusely reflective characteristic. Another example of a plastic material with a suitable diffusive reflectivity is White97 plastic from Whiteoptics™ of USA. Alternatively, the compartments may comprise a rigid substrate having an interior surface, and a diffusively reflective paint layer formed on the interior surface of the substrate so as to provide the diffusively reflective interior surface of the compartments. A coating material with a suitable diffusive reflectivity is available from Whiteoptics™ as well.

The light dome sits directly below the heat sink, and its top surface matches the adjacent surface of the heat sink. The light dome has a plurality of openings that match the output windows of the LEDs so that the LED light emission can be introduced into the light scrambling compartments. The light dome is made of a plastic material with highly efficient diffusively reflectivity or a rigid substrate material coated with highly reflective paint. It can also be made of a rigid material deposited with high reflectivity specular coating or film. A film with suitable reflectivity is Vikuiti™ ESR of 3M.

The heat sink of the present invention may have a plurality of cutouts that make the heat sink have an octopus-like shape. These cutouts provide the paths for the light to reach a substantially large angular space in the upper hemisphere. While various numbers of cutouts are within the scope of the present invention, the preferred embodiment of the present invention has three or six cutouts. These cutouts are evenly spaced on the outer perimeter of the heat sink to achieve good aesthetics in design. Moreover, the cutouts extend outwards so that their sidewalls can help to deflect light into the upper hemisphere. The sidewalls are coated with diffusively reflective material.

Inside the heat sink, according to the preferred embodiment, a cutout in the lower portion forms a lower housing to host the light dome, while a cutout in the upper portion forms an upper housing to host the electrical AC/DC conversion and control driver in combination with inner housing of the electrical connector. There is an additional through-hole connecting the lower housing and the upper housing. This hole is used for electrical and control wiring between the electrical AC/DC conversion and control driver and the LEDs.

The heat sink of the present invention is made of thermally conductive materials such as aluminum or ceramics. The interior surface of the lower housing is finished for LED mounting. In general, the LEDs can be mounted anywhere on the interior surface in any pattern. The preferred mounting locations should eliminate or reduce the light rays that may come out of the output globe without being diffused inside the light scrambling compartments at least once. Also, the LEDs are arranged in such a way that they supply radiant energy in exactly the same pattern to all the light scrambling compartments. The outer surface of the heat sink is coated with heat dissipation material for improved heat convection and/or radiation. Other surface features like fins can be used to increase the surface area for improved heat convection as well.

In some of the embodiments of the present invention, the output globe and the light dome form a completely airtight globe. In other embodiments of the present invention, when the light dome is replaced by the highly diffusively reflective coating directly on the interior surface of the heat sink's lower housing, the output globe and the heat sink form a completely airtight globe. Therefore, the light scrambling compartments is kept clean.

The output globe of the present invention may have a globe shape, and has a plurality of cutouts. These cutouts are complimentary with the cutouts of the heat sink or the light dome. Therefore, the output globe can form a completely airtight globe with either the light dome or the heat sink. In some embodiments of the present invention, the output globe is made of transparent plastic material such as PMMA or polycarbonate (PC), commercially available from many manufacturers. In some other embodiments of the present invention, the output globe is made of translucent plastic material such as PLEXIGLAS SATINICE®, commercially available from Degussa (Germany). The output globe provides the housing for the light distribution plate and the light divider, while the light scrambling compartments reside inside the output globe.

The light distribution plate of the present invention can be a thin disc plate. The light distribution plate is made of a plastic material with highly efficient diffusive reflectivity or a rigid substrate material coated with highly reflective paint. It can also be made of a rigid material deposited with high reflectivity specular coating or film. The light distribution plate may have a plurality of holes. It regulates how much light gets passed through and how much light gets reflected back into the light scrambling compartments, towards the side way and/or the upper hemisphere by controlling the size and number of holes. It is further understood that the light distribution plate can be cut with many different hole opening sizes and shapes including circular, oval, rectangular, and hexagonal or other multiple sides and shapes in the same plate in the same time. To eliminate any possible optical artifacts such as the Moire rings, irregular hole opening patterns may be preferable. Moreover, according to the present invention, light distribution can be further fine-tuned by changing the surface contour of the light distribution plate by introducing localized micro curvatures. The light distribution plate sits evenly on the bottom inside the output globe and right below the light divider.

The light divider in the present invention may have a small shaft with a plurality of blades. While various numbers of blades are within the scope of the present invention, the preferred embodiment of the present invention has three blades that are 120 degrees apart around the shaft. In some embodiments of the present invention, the light divider sits directly on top the light distribution plate, inside the output globe, and right below the light dome, with its blades' outside perimeters in close contact with the interior surface of the output globe and the light dome. As a result, three light scrambling compartments are well defined. In other embodiments of the present invention, when the light dome is not used, the light divider sits directly on top the light distribution plate, inside the output globe, and right below the heat sink, with its blades' outside perimeters in close contact with the interior surface of the output globe and the heat sink. Also, three light scrambling compartments are well defined. The light divider's blades are lined up with the centerline of the cutouts in the heat sink so as not to interference with the LEDs mounted on the interior surface of the heat sink.

In some embodiments of the present invention, the light divider is made of a plastic material with highly efficient diffusive reflectivity. In other embodiments of the present invention, the light divider is made of a rigid substrate material coated with highly diffusively reflective paint. According to the present invention, light scrambling and light distribution can be further fine-tuned by changing the surface contour of the light divider by introducing localized micro curvatures.

Cool white light LEDs and warm white light LEDs are commercially available from Cree, Philip Lumileds, Osram, etc. These LEDs can be used in the present invention to produce a complete LED lighting device with color rendering index (CRI) specified by the LED vendors. To make sure all the light output from the standard LEDs will hit the light divider at least once before exiting from the output globe, the preferred embodiment of the present invention uses a small specular mirror right beside the LEDs to re-direct the high angle light rays towards the light divider plate, if necessary. Because the present invention provides more than adequate means to have all the light fully diffused and scrambled in the light scrambling compartments, a substantially transparent output globe can be used. Compared to the translucent output globe that is routinely used in most existing LED light bulbs, a transparent output globe can improve overall lighting efficiency.

It is widely understood that remote phosphors can improve color reproduction and luminous efficacy. Down-conversion phosphors, up-conversion phosphors, as well as RGB quantum dots may be used in the present invention. Remote phosphors can be applied in the present invention in many different ways. In some embodiments of the present invention, the light divider is made of a plastic material embedded with a plurality of phosphor particles. In other embodiments of the present invention, the light divider is made of a transparent plastic material coated with a plurality of phosphor particles. In still other embodiments of the present invention, the light divider is made of a rigid substrate material deposited with high reflective specular coating first, then coated with a plurality of phosphor particles. Because the phosphor particles are usually significant larger than the wavelength of visible light, light scattering occurs when a primary wavelength light hits the phosphor layer. This primary wavelength light interacts with the phosphor layer, and gives rise to several output light components: forward unconverted primary light, backward unconverted primary light, forward converted light, and backward converted light. In the present invention, all the light has a greatly improved chance of exiting the output globe without being absorbed, because the light scrambling compartments are an open structure. As a result, the luminous efficacy is improved.

In the present invention, color reproduction and luminous efficacy can be further improved because there is great flexibility in applying the phosphors to the surface of the light divider. Different phosphors can be applied to different areas on the light divider surface. Based on the need to proportionally generate a certain amount of converted light, the corresponding phosphor can occupy a proportional area on the light diver surface. For example, if more converted red light is needed than the converted green light, the red phosphor will be given a larger area compared to the green phosphor. Moreover, different phosphors can be coated alternately on the adjacent areas in order to have well-defined different phosphor cells on the light divider surface. These alternating phosphor cells can minimize multi-phosphor self-absorption, while providing superior color scrambling. Techniques such as spray printing, screen printing, or ink jet printing can be used to produce these alternating phosphor cells.

There have been extensive studies on achieving warm white light using blue LEDs or near-UV LEDs in combination with remote phosphors. Blue light LEDs or near-UV LEDs are commercially available from Cree, Philip Lumileds, Osram, etc. In the present invention, these LEDs can be used together with the remote phosphors on the light divider surface to produce a complete LED lighting device with high color rendering index (CRI). To make sure substantial amount of the light output from the standard LEDs will hit the light divider at least once before exiting from the output globe, the preferred embodiment of the present invention uses a small mirror right beside the LEDs to re-direct the high angle light rays towards the light divider surface, if necessary. Because the present invention provides more than adequate means to have all the light fully diffused and scrambled in the light scrambling compartments, a substantially transparent output globe can be used. Compared to the translucent output globe that is routinely used in most existing LED light bulbs, a transparent output globe can improve overall lighting efficiency.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates the preferred shape of the LED lighting device according to the present invention.

FIG. 2 is the exploded view of a preferred embodiment of the LED lighting device according to the present invention.

FIG. 3 is the side view of a typical LED.

FIG. 4 illustrates the attachment of LEDs to the heat sink in the present invention.

FIG. 5 illustrates an airtight globe in some embodiments of the present invention and light scrambling compartments of a preferred embodiment.

FIG. 6 illustrates the light dome of a preferred embodiment.

FIG. 7 illustrates the heat sink of a preferred embodiment.

FIG. 8 illustrates another airtight globe in some other embodiments of the present invention.

FIG. 9 illustrates the output globe of a preferred embodiment.

FIG. 10a illustrates one embodiment of the light distribution plate in the present invention.

FIG. 10b is the top view illustrating another embodiment of the light distribution plate in the present invention.

FIG. 11a shows light reflection from a flat surface with specular coating or film.

FIG. 11b shows light reflection from a flat diffusing surface.

FIG. 12a shows light reflection from a micro mirror on a flat surface with specular coating or film.

FIG. 12b shows light reflection from a flat diffusing surface with localized curvature change.

FIG. 13 illustrates the light divider structure of a preferred embodiment.

FIG. 14 is the side view of a typical LED with a small mirror attached.

FIG. 15 illustrates phosphor particles applied to the light divider surface.

### DETAILED DESCRIPTION OF THE INVENTION

Embodiments of the invention are described herein with reference to schematic illustrations of embodiments of the invention. Embodiments of the invention should not be construed as limited to the particular shapes of the regions illustrated herein but are to include deviations in shapes that result, for example, from manufacturing techniques and/or tolerances. A region illustrated or described as square or rectangular will typically have rounded or curved features due to normal manufacturing tolerances. Thus, the regions illustrated in the figures are schematic in nature and their shapes are not intended to illustrate the precise shape of a region of a device and are not intended to limit the scope of the invention.

The present invention will now be described with reference to FIG. 1. While various shapes of the lighting devices are within the scope of the present invention, the preferred embodiment of the present invention has a shape and form factor closely resembling the incandescent light bulb. In a particular embodiment, the combined shape of the heat sink and the output globe forms a standard A19 light bulb shape 50.

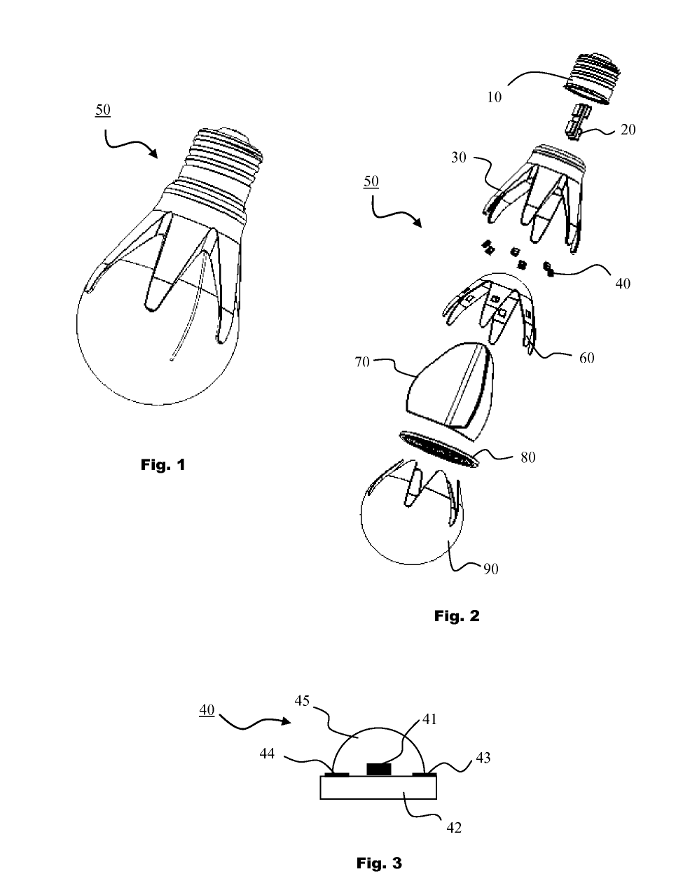

As illustrated in FIG. 2, the LED lighting device of the present invention comprises an electrical connector 10, an electrical AC/DC conversion and control driver 20, a heat sink 30, a plurality of semiconductor light emitting diodes (LEDs) 40, a light dome 60, a light divider 70, a light distribution plate 80, and an output globe 90. The electrical wires connecting the electrical connector 10, the electrical AC/DC conversion and control driver 20, and the light emitting diodes (LEDs) 40 are not shown. The light dome 60, the light divider 70 and the light distribution plate 80 form a plurality of diffusively reflective compartments for effective light scrambling before the light exits the highly efficient output globe 90. The light redistribution plate 80, together with a shaped output globe 90 and a matching heat sink 30, further enhances omni-directional lighting distribution.

The electrical power connector 10 of the lighting device may be a standard Edison-type screw connector such that the lighting device can be used to replace a standard incandescent light bulb.

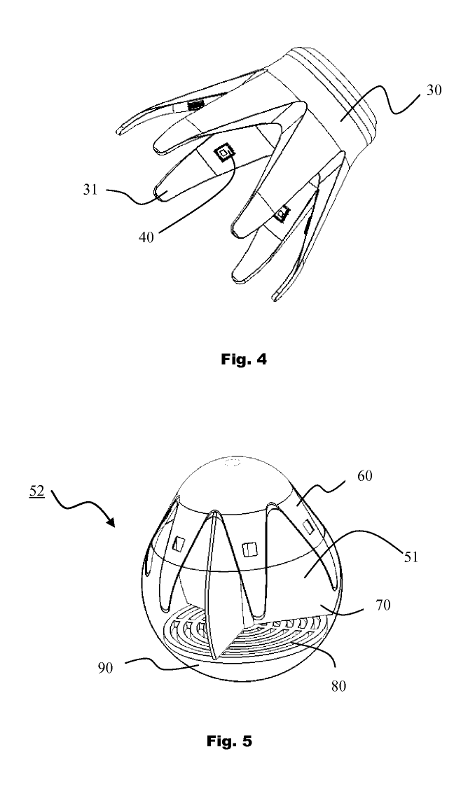

FIG. 3 illustrates a typical LED 40. The LED 40 typically consists of a light-emitting element called the LED die or LED chip 41, a chip carrier called the sub-mount 42, an electrical lead anode 43, an electrical lead cathode 44, and a lens 45. The sub-mount 42 is usually thermally conductive but electrically non-conductive. The lens 45 is usually formed by silicone packaging material. More than one LED chip 41 can be packaged into the same sub-mount as well. The LEDs are commercially available from a number of manufacturers, such as Cree, Philips Lumileds, and Osram. The LEDs without a lens from these producers can be used as well. These vendors also supply LEDs with or without phosphors included in the package. The phosphors are usually embedded within the silicone packaging material, or coated on the lens surface (not shown). In the present invention, the LEDs 40 may be distributed and directly attached to the interior surface 31 of the heat sink 30 by means such as soldering, as shown in FIG. 4. As a result, a very short thermal path to the outer surface of the heat sink is achieved. Although LEDs produced by different manufacturers come in different form sizes, and attachment methods, all can be made to fit into the lighting device 50 shown in FIG. 1. The LED lighting device of the present invention may utilize a few groups of LEDs to achieve desired color rendering index (CRI) in some embodiments, with each group LEDs emitting a different dominant color.

As illustrated in FIG. 5, the disclosed apparatus may use a variety of different structures or arrangements for the light scrambling compartments 51 formed by the light dome 60, the light divider 70, the light distribution plate 80, and the output globe 90. The preferred embodiment of the present invention has three light scrambling compartments 51. These three compartments divide the inner space of the output globe evenly into three parts. It is desirable that the interior compartment surfaces have a highly efficient diffusively reflective characteristic, e.g. a reflectivity of over 95%, with respect to the relevant wavelengths, in order to maximize the optical efficiency. For example, the compartments can be formed of a diffusively reflective plastic material, such as MC-PET from Furukawa Electric of Japan, having a 98% reflectivity and a diffusely reflective characteristic. Another example of a plastic material with a suitable diffusive reflectivity is White97 plastic from Whiteoptics™ of USA. Alternatively, the compartments may comprise a rigid substrate having an interior surface, and a diffusively reflective paint layer formed on the interior surface of the substrate so as to provide the diffusively reflective interior surface of the compartments. A coating material with a suitable diffusive reflectivity is available from Whiteoptics™ as well.

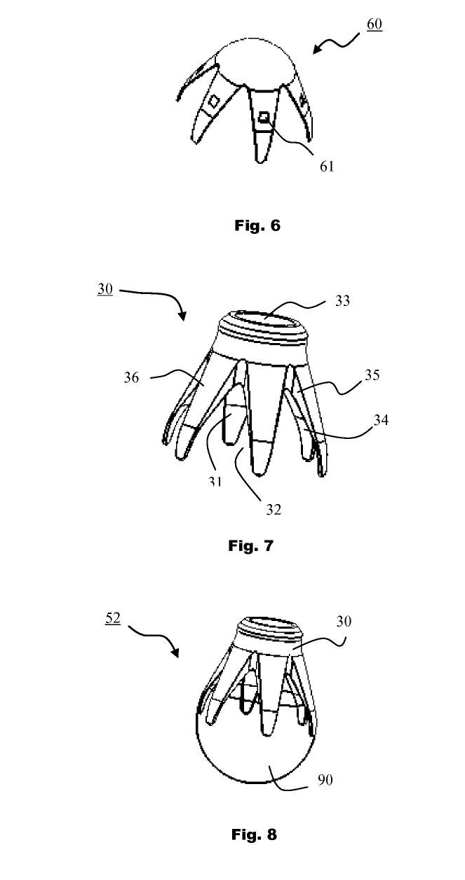

FIG. 6 illustrates the light dome in the preferred embodiment of the present invention. The light dome 60 sits directly below the heat sink, and its top surface matches the adjacent surface of the heat sink 30. The light dome 60 has a plurality of openings 61 that match the output windows of the LEDs so that the LED light emission can be introduced into the light scrambling compartments. The light dome 60 is made of a plastic material with highly efficient diffusive reflectivity or a rigid substrate material coated with highly reflective paint. It can also be made of a rigid material deposited with high reflectivity specular coating or film. A film with suitable reflectivity is Vikuiti™ ESR of 3M.

As illustrated in FIG. 7, the heat sink 30 of the present invention may have a plurality of cutouts 34 that make the heat sink 30 have an octopus-like shape. These cutouts provide the paths for the light to reach a substantially large angular space in the upper hemisphere. While various numbers of cutouts are within the scope of the present invention, the preferred embodiment of the present invention has three or six cutouts. These cutouts are evenly spaced on the outer perimeter of the heat sink to achieve good aesthetics in design. Moreover, the cutouts 34 extend outwards so that their sidewalls 35 can help to deflect light into the upper hemisphere. The sidewalls 35 are coated with diffusively reflective material, which is not shown.

Inside the heat sink 30, according to the preferred embodiment, a cutout in the lower portion forms a lower housing 32 to host the light dome 60 and a cutout in the upper portion forms an upper housing 33 to host the electrical AC/DC conversion and control driver 20 in combination with the electrical connector 10. There is an additional through-hole (not shown) connecting the lower housing 32 and the upper housing 33. This hole is used for electrical and control wiring between the electrical AC/DC conversion and control driver 20 and the LEDs 40.

The heat sink 30 of the present invention is made of thermally conductive materials such as aluminum or ceramics. The interior surface 31 of the lower housing 32 is finished for LED mounting. In general, the LEDs 40 can be mounted anywhere on the interior surface 31 of the lower housing 32 in any pattern. The preferred mounting locations should eliminate or reduce the light rays that may come out of the output globe without being diffused inside the light scrambling compartments at least once. Also, the LEDs 40 are arranged in such a way that they supply radiant energy in exactly the same pattern to all the light scrambling compartments. The outer surface of the heat sink 30 is coated with heat dissipation material 36 for improved heat convection and/or radiation. Other surface features like fins can be used to increase the surface area for improved heat convection as well.

In some of the embodiments of the present invention, as illustrated in FIG. 5, the output globe 90 and the light dome 60 form a completely airtight globe 52. In some other embodiments of the present invention, when the light dome is replaced by a highly diffusively reflective coating on the interior surface of the heat sink's lower housing 32, as illustrated in FIG. 8, the output globe 90 and the heat sink 30 form another completely airtight globe 52. Therefore, the light scrambling compartments is kept clean.

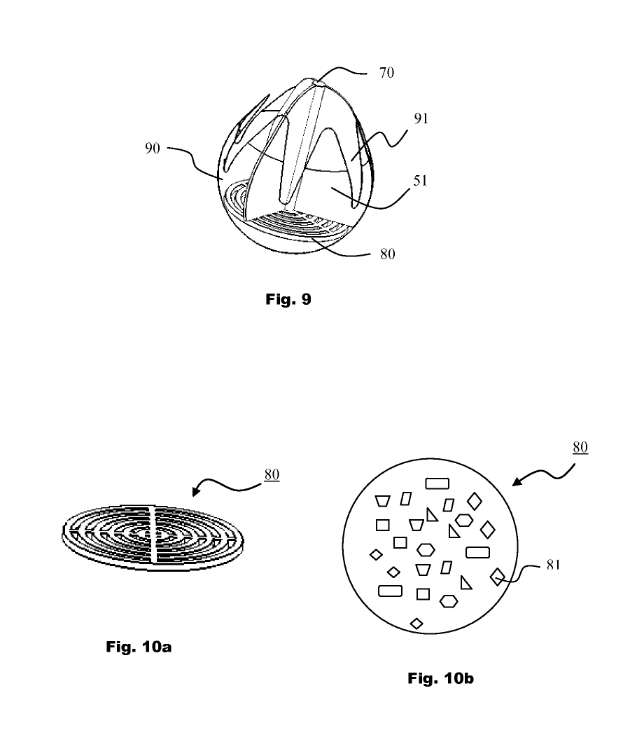

The output globe 90 of the present invention may have a globe shape, as illustrated in FIG. 9, and have a plurality of cutouts 91. These cutouts are complimentary with the cutouts of the heat sink 30 or the light dome 60. Therefore, the output globe 90 can either form a completely airtight globe 52 with the light dome 60 as illustrated in FIG. 5, or form a completely airtight globe 52 with the heat sink 30 as illustrated in FIG. 8. In some embodiments of the present invention, the output globe 90 is made of substantially transparent plastic material such as PMMA or polycarbonate (PC), commercially available from many manufacturers. In other embodiments of the present invention, the output globe 90 is made of translucent plastic material such as PLEXIGLAS SATINICE®, commercially available from Degussa (Germany). The output globe 90 provides the housing for the light distribution plate 80 and the light divider 70, and the light scrambling compartments 51 reside inside the output globe 90.

As illustrated in FIG. 10a and FIG. 10b, the light distribution plate 80 of the present invention may be a thin disc plate. The light distribution plate is made of a plastic material with highly efficient diffusive reflectivity or a rigid substrate material coated with highly reflective paint. It can also be made of a rigid material deposited with specular coating or film of high reflectivity. The light distribution plate 80 may have a plurality of holes 81. It regulates how much light gets passed through and how much light gets reflected back into the light scrambling compartments, or towards the sideway or the upper hemisphere by controlling the size and number of holes 81. It is further understood that the light distribution plate 80 can be cut with many different hole opening sizes and shapes including circular, oval, rectangular, and hexagonal or other multiple side shapes in the same plate at the same time. To eliminate any possible optical artifacts such as Moire rings, irregular hole opening patterns may be preferable. The light distribution plate 80 sits evenly at the bottom inside the output globe 90 and right below the light divider 70.

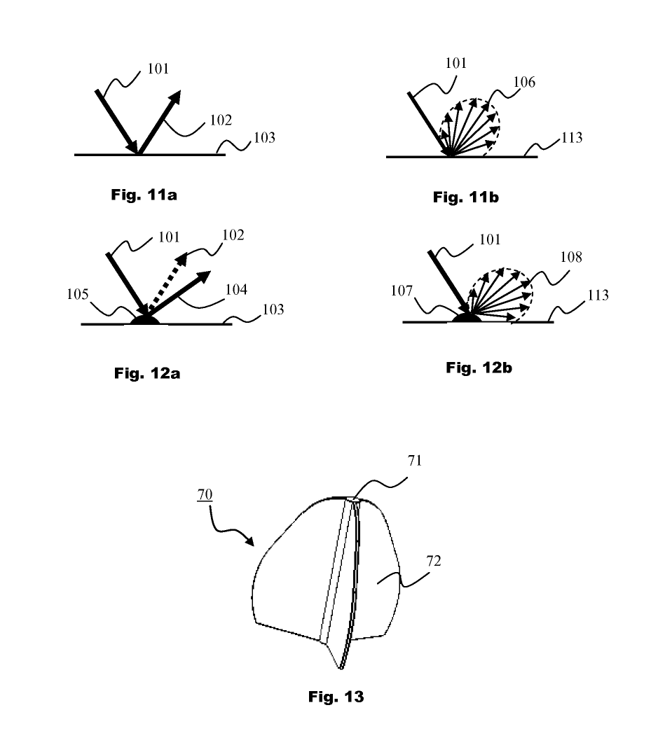

According to the present invention, light distribution can be further fine-tuned by changing the surface contour of the light distribution plate 80 by introducing localized micro curvatures. As shown in FIG. 11a, when the incident light 101 hits a flat surface 103 with specular reflective coating or film, the reflected light 102 has a reflection angle equal to the incident angle. When light is incident on a diffusively reflective flat surface, however, the incident ray is reflected at many angles rather than at just one angle as in the case of specular reflection. An illuminated ideal diffuse reflecting surface will have equal luminance from all directions in the hemisphere surrounding the surface (Lambertian reflectance). In reality, many common diffusing materials exhibit a mixture of specular and diffuse reflection. As shown in FIG. 11b, when the incident light 101 hits a diffusing surface 113, the reflected light 106 exhibits some residual specular reflection on top of diffuse reflection. These reflection characteristics can be utilized to fine-tune light distribution in the present invention. As shown in FIG. 12a, when the incident light 101 hits a flat surface 103 with local micro-curvature 105, the reflected light 104 deviates away from the original reflection light 102. Therefore, when local micro-curvature is applied to the light distribution plate surface that has a specular coating or film, the resulting micro mirrors can help to fine tune the light distribution. Similarly, as illustrated in FIG. 12b, when the incident light 101 hits a diffusing surface 113, the local micro curvature 107 will help to diffuse the reflected light 108 to a new dominant direction in line with the residual specular reflection. Therefore, when local micro-curvature is applied to the light distribution plate surface that is diffusive, the resulted micro diffusing elements can help to fine tune the light distribution. Although a convex curvature is shown in FIG. 12a and FIG. 12b, a concave curvature can also be used in the present invention

The light divider 70 in the present invention may have small shaft 71 with a plurality of blades 72, as illustrated in FIG. 13. While various numbers of blades are within the scope of the present invention, the preferred embodiment of the present invention has three blades that are 120 degrees apart around the shaft. In some embodiments of the present invention, the light divider 70 sits directly on top of the light distribution plate 80, inside the output globe 90, and right below the light dome 60, with its blades' outside perimeters in close contact with the interior surface of the output globe 90 and the light dome 60. As a result, three light scrambling compartments are well defined. In other embodiments of the present invention, when the light dome 60 is not used, the light divider 70 sits directly on top of the light distribution plate 80, inside the output globe 90, and right below the heat sink 30, with its blades' outside perimeters in close contact with the interior surface of the output globe 90 and the heat sink 30. Also, three light scrambling compartments are well defined. The light divider's blades 72 are lined up with the centerline of the cutouts 34 in the heat sink 30 so as to not interference with the LEDs 40 mounted on the interior surface 31 of the heat sink 30.

In some embodiments of the present invention, the light divider 70 is made of a plastic material with highly efficient diffusive reflectivity. In other embodiments of the present invention, the light divider 70 is made of a rigid substrate material coated with highly diffusively reflective paint. According to the present invention, light scrambling and light distribution can be further fine-tuned by changing the surface contour of the light divider 70 by introducing localized micro curvatures, just as illustrated in FIG. 12b.

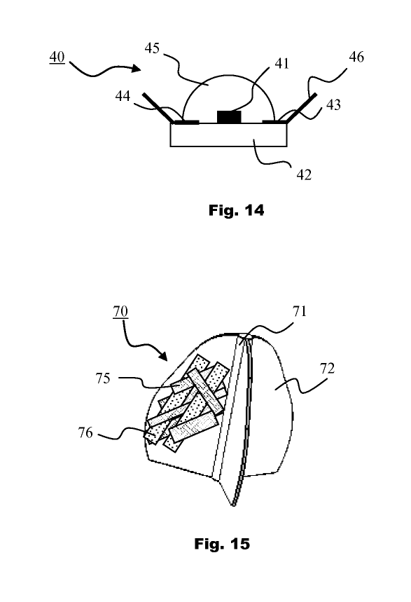

Cool white light LEDs and warm white light LEDs are commercially available from Cree, Philip Lumileds, Osram, etc. These LEDs can be used in the present invention to produce a complete LED lighting bulb with color rendering index (CRI) specified by the LED vendors. To make sure a substantially amount of light output from the standard LEDs hits the light divider 70 at least once before exiting from the output globe 90, as illustrated in FIG. 14, a preferred embodiment of the present invention uses a small specular mirror 46 right beside the LEDs chip 41 to re-direct the high angle light rays towards the light divider 70, if necessary. Because the present invention provides more than adequate means to have all the light fully diffused and scrambled in the light scrambling compartments, a substantially transparent output globe can be used. Compared to the translucent output globe that is routinely used in most existing LED light bulbs, a transparent output globe can improve overall lighting efficiency.

It is widely understood that remote phosphors can improve color reproduction and luminous efficacy. Down-conversion phosphors, up-conversion phosphors, as well as RGB quantum dots may be used. Remote phosphor particles can be applied in the present invention in many different ways. In some embodiments of the present invention, the light divider 70 is made of a plastic material embedded with a plurality of phosphor particles. In other embodiments of the present invention, the light divider 70 is made of a transparent plastic material coated with a plurality of phosphors particles. In still other embodiments of the present invention, the light divider 70 is made of a rigid substrate material deposited with a highly reflective specular coating first, then coated with a plurality of phosphor particles. Because the phosphor particles are usually significantly larger than the wavelength of visible light, light scattering occurs when a primary wavelength light hits the phosphor layer. This primary wavelength light interacts with the phosphor layer, and gives rise to a few output light components: forward unconverted primary light, backward unconverted primary light, forward converted light, and backward converted light. In the present invention, all the light has a greatly improved chance of exiting the output globe 90 without being absorbed, because the light scrambling compartments are an open structure. As a result, the luminous efficacy is improved.

In the present invention, color reproduction and luminous efficacy can be further improved because there is great flexibility in applying the phosphor particles to the surface of the light divider 70. Different phosphor particles can be applied to different areas on the light divider surface. Based on the need to proportionally generate a certain amount of converted light, the corresponding phosphor particles can occupy a proportional area on the light diver surface. For example, if more converted red light is needed than the converted green light, the red phosphor will have a larger area than that of the green phosphor. Moreover, different phosphor particles can be coated alternately on the adjacent areas in order to have well-defined different phosphor cells on the light divider surface. As illustrated in FIG. 15, two different phosphor particles are alternately applied to the surface 72 of light divider 70, and form a plurality of phosphor cells: cells 75 formed by the first phosphor particles and cells 76 formed by the second phosphor particles. It is further understood that a plurality of phosphors can be applied to the surface 72 of light divider 70, and the phosphor cells may have many different sizes and shapes including circular, oval, rectangular, and hexagonal or other multiple side shapes. These interleaving phosphor cells can minimize multi-phosphor self-absorption, while providing superior color mixing. Techniques such as spray printing, screen printing, or ink jet printing can be used to produce these alternating phosphor cells.

There have been extensive studies on achieving warm white light using blue LEDs or near-UV LEDs in combination with remote phosphors. Blue light LEDs or near-UV LEDs are commercially available from Cree, Philip Lumileds, Osram, etc. In the present invention, these LEDs can be used together with the remote phosphors on the light divider surface to produce a complete LED lighting bulb with high color rendering index (CRI). To make sure a substantial amount of the light output from the standard LEDs hits the light divider 70 first before exiting from the output globe 90, as illustrated in FIG. 14, a preferred embodiment of the present invention uses a small specular mirror 46 right beside the LEDs chip 46 to re-direct the high angle light rays towards the light divider plate 70, if necessary. Because the present invention provides more than adequate means to have all the light fully diffused and scrambled in the light scrambling compartments, a substantially transparent output globe can be used. Compared to the translucent output globe that is routinely used in most existing LED light bulbs, a transparent output globe can improve luminous efficacy.

The preferred embodiments of the present invention will now be described with reference to FIG. 2.

In a first preferred embodiment of the present invention, the LED lighting device 50 of the present invention has an electrical connector 10, an electrical AC/DC conversion and control driver 20, and a heat sink 30. The electrical AC/DC conversion and control driver 20 is hosted by the inner housing of the electrical connector 10 and the upper housing 33 of the heat sink 30. A plurality of warm white LEDs 40, commercially available from many manufacturers, are attached to the interior surface of the lower housing 32 of the heat sink 30 by means such as soldering. The electrical wires connecting the electrical connector 10, the electrical AC/DC conversion and control driver 20, and a plurality of warm white LEDs 40 are not shown. The heat sink 30 has a plurality of cutouts 34 that provide the paths for the light to reach a substantially large angular space in the upper hemisphere. These cutouts are evenly spaced on the outer perimeter of the heat sink 30 and extend outwards so that their sidewalls 35 can help to deflect light into the upper hemisphere. The sidewalls 35 are coated with diffusively reflective material. The heat sink 30 of the present invention is made of thermally conductive materials such as aluminum or ceramics. The outer surface 36 of the heat sink 30 is coated with heat dissipation material for improved heat convection and/or radiation. Other outside surface features like fins can be used to increase the surface area for improved heat convection as well. The light dome 60 sits directly below the heat sink 30, and its top surface matches the adjacent surface of the heat sink 30. The light dome 60 has a plurality of openings 61 that match the output windows of the LEDs 40 so that the LED light emission can be introduced into the light scrambling compartments below the light dome 60. The light dome 60 is made of a rigid substrate material deposited with high specular reflectivity coating or film. The light dome 60 has a tight fit with the output globe 90, and they form a completely airtight globe. A thin disc-like light distribution plate 80 sits evenly at the bottom inside the output globe 90. On top of the light distribution plate 80 is a light divider 70, which has a small shaft 71 and 3 blades 72. These blades are 120 degrees apart around the shaft 71, and are lined up with the centerline of the cutouts 34 in the heat sink 30. Also, the blades' outside perimeters are in close contact with the interior surface of the output globe 90, the interior surface of the light dome 60 on the top, and the top surface of the light distribution plate 80 at the bottom, so that three well-defined light scrambling compartments form inside the airtight globe. Both the light divider 70 and the light distribution plate 80 are made of a plastic material with highly efficient diffusive reflectivity. The light distribution plate 80 has a plurality of holes to regulate how much light gets passed through and how much light gets reflected back into the light scrambling compartments, or the upper hemisphere outside the light scrambling compartments, by controlling the size and number of holes. Also, the light distribution plate 80 has a micro curvature structure on its top surface to fine-tune light distribution. The LEDs 40 are mounted on the interior surface 31 of the heat sink 30 in such a way that it can reduce the light rays that may come out of the output globe 90 without being diffused inside the light scrambling compartments at least once, and it can supply radiant energy in exactly the same pattern to all the light scrambling compartments. Also, a small specular mirror 46 is placed right beside the LEDs 40 to reduce the emerging light angle from up to 180 degrees to less than 90 degrees. Therefore, all the light rays are diffused inside the light scrambling compartments at least once before they come out of the output globe 90. The output globe 90 is substantially transparent.

In a second preferred embodiment of the present invention, the LED lighting device of the present invention has an electrical connector 10, an electrical AC/DC conversion and control driver 20, and a heat sink 30. The electrical AC/DC conversion and control driver 20 is hosted by the inner housing of the electrical connector 10 and the upper housing 33 of the heat sink 30. A plurality first group of cool white LEDs 40 are attached to the interior surface 31 of the lower housing 32 of the heat sink 30 by means such as soldering. These cool white LEDs lack a red light component. A plurality second group of red LEDs 40, emitting light with a dominant wavelength around 630 nm, are also attached to the interior surface 31 of the lower housing 32 of the heat sink 30 by means such as soldering. The electrical wires connecting the electrical connector 10, the electrical AC/DC conversion and control driver 20, and the cool white LEDs and red LEDs 40 are not shown. The heat sink 30 has a plurality of cutouts 34 that provide the paths for the light to reach a substantially large angular space in the upper hemisphere. These cutouts are evenly spaced on the outer perimeter of the heat sink 30 and extend outwards so that their sidewalls 35 can help to deflect light into the upper hemisphere. The sidewalls 35 are coated with diffusively reflective material. The heat sink 30 of the present invention is made of thermally conductive materials such as aluminum or ceramics. The outer surface 36 of the heat sink 30 is coated with heat dissipation material for improved heat convection and/or radiation. Other outside surface features like fins can be used to increase the surface area for improved heat convection as well. The interior surface 31 of the heat sink's lower housing 32 is coated with highly diffusively reflective paint. The heat sink 30 has a tight fit with an output globe 90, and they form a completely airtight globe. A thin disc-like light distribution plate 80 sits evenly at the bottom inside the output globe 90. On top of the light distribution plate 80 is a light divider 70, which has a small shaft 71 and 3 blades 72. These blades are 120 degrees apart around the shaft 71, and are lined up with the centerline of the cutouts 34 of the heat sink 30. Also, the blades' outside perimeters are in close contact with the interior surface of the output globe 90, interior surface 31 of the heat sink's lower housing 32 on the top, and the top surface of the light distribution plate 80 at the bottom, so that three well-defined light scrambling compartments form inside the airtight globe. Both the light divider 70 and the light distribution plate 80 are made of a plastic material with highly efficient diffusive reflectivity. The light distribution plate 80 has a plurality of holes to regulate how much light gets passed through and how much light gets reflected back into the light scrambling compartments, or the upper hemisphere outside the light scrambling compartments, by controlling the size and number of holes. Also, the light distribution plate 80 has a micro curvature structure on its top surface to fine tune light distribution. The two groups of LEDs 40 are mounted on the interior surface 31 of the heat sink 30 in such a way that it can reduce the light rays that may come out of the output globe without being diffused inside the light scrambling compartments at least once, and it can supply radiant energy in exactly the same pattern to all the light scrambling compartments. Also, a small specular mirror 46 is placed right beside the LEDs 40 to reduce the emerging light angle from up to 180 degrees to less than 90 degrees. Therefore, all the light rays will go through diffusing inside the light scrambling compartments at least once before they come out of the output globe 90. The output globe 90 is substantially transparent.

In a third preferred embodiment of the present invention, the LED lighting device of the present invention has an electrical connector 10, an electrical AC/DC conversion and control driver 20, and a heat sink 30. The electrical AC/DC conversion and control driver 20 is hosted by the inner housing of the electrical connector 10 and the upper housing 33 of the heat sink 30. A plurality of blue LEDs 40, with dominant wavelength around 450 nm, are attached to the interior surface 31 of the lower housing 32 of the heat sink 30 by means such as soldering. The electrical wires connecting the electrical connector 10, the electrical AC/DC conversion and control driver 20, and the blue LEDs 40 are not shown. The heat sink 30 has a plurality of cutouts 34 that provide the paths for the light to reach a substantially large angular space in the upper hemisphere. These cutouts 34 are evenly spaced on the outer perimeter of the heat sink 30 and extend outwards so that their sidewalls 35 can help to deflect light into the upper hemisphere. The sidewalls 35 are coated with diffusively reflective material. The heat sink 30 of the present invention is made of thermally conductive materials such as aluminum or ceramics. The outer surface 36 of the heat sink 30 is coated with heat dissipation material for improved heat convection and/or radiation. Other outside surface features like fins can be used to increase the surface area for improved heat convection as well. The light dome 60 sits directly below the heat sink, and its top surface matches the adjacent surface of the heat sink 30. The light dome 60 has a plurality of openings 61 that match the output windows of the LEDs 40 so that the LED light emission can be introduced into the light scrambling compartments below the light dome 60. The light dome 60 is made of a rigid substrate material deposited with high specular reflectivity coating or film. The light dome 60 has a tight fit with the output globe 90, and they form a completely airtight globe. A thin disc-like light distribution plate 80 sits evenly at the bottom inside the output globe 90. On top of the light distribution plate 80 is a light divider 70, which has a small shaft 71 and 3 blades 72. These blades 72 are 120 degrees apart around the shaft 71, and are lined up with the centerline of the cutouts 34 in the heat sink 30. Also, the blades' outside perimeters are in close contact with the interior surface of the output globe 90, the interior surface of the light dome 60 on the top, and the top surface of the light distribution plate 80 at the bottom, so that three well-defined light scrambling compartments form inside the airtight globe. The light divider 70 is made of a substantially transparent plastic material coated with two phosphor particles: green phosphor and red phosphor. The green phosphor absorbs the blue light emitted by the blue LEDS 40 and produces an excited light having a emission peak in a visible wavelength range from green to yellow (in the range of about 530 nm to 580 nm), and having a spectrum bandwidth (full width of half maximum) of about 80 nm to 100 nm. The red phosphor absorbs the blue light emitted by the blue LEDS 40 and produces an excited light having a emission peak in a visible wavelength range from yellow to red (in the range of about 580 nm to 630 nm), and having a spectrum bandwidth (full width of half maximum) of about 80 nm to 100 nm. The two phosphors can be applied to different areas on the light divider surface. Based on the need to proportionally generate a certain amount of converted light, the corresponding phosphor can occupy a proportional area on the light diver surface. For example, if more converted red light is needed than the converted green light, the red phosphor will have a larger area than the green phosphor. Moreover, two phosphors can be coated alternately on the adjacent areas to have well-defined different interleaving phosphor cells on the light divider surface. The light distribution plate 80 is made of a plastic material with highly efficient diffusive reflectivity. The light distribution plate 80 has a plurality of holes to regulate how much light gets passed through and how much light gets reflected back into the light scrambling compartments, or the upper hemisphere outside the light scrambling compartments by controlling the size and number of holes. Also, the light distribution plate 80 has a micro curvature structure on its top surface to fine-tune light distribution. The LEDs 40 are mounted on the interior surface 31 of the heat sink 30 in such a way that it can reduce the light rays that may come out of the output globe without being diffused inside the light scrambling compartments at least once, and it can supply radiant energy in exactly the same pattern to all the light scrambling compartments. Also, a small specular mirror 46 is placed right beside the LEDs 40 to reduce the emerging light angle from up to 180 degrees to less than 90 degrees. Therefore, all the light rays will go through diffusing inside the light scrambling compartments at least once before they come out of the output globe 90. The output globe 90 is substantially transparent.

Although the present invention is illustrated in connection with specific embodiments for instructional purposes, the present invention is not limited thereto. Various combinations, adaptations and modifications may be made without departing from the scope of the invention. Therefore, the spirit and scope of the appended claims should not be limited to the foregoing description.

### CITATION LIST

U.S. PATENT DOCUMENTS

| | | |
|---|---|---|
| 7,600,882 B1 | October 2009 | Morejon et al |
| 7,744,243 B2 | June 2011 | Van De Ven et al |
| 7,909,481 B1 | March 2011 | Zhang et al |
| 7,960,872 B1 | June 2011 | Zhai et al |
| 2011/0080096 A1 | April 2011 | Dudik et al |

What is claimed is:

1. An LED lighting device comprising:
an electrical connector;
an electrical AC/DC conversion and control driver;
a heat sink having a first end and a second end;
a plurality of semiconductor light emitting diodes (LEDs) mounted near the second end of the heat sink; and
a light scrambling means comprising:
an output globe; and
a light divider inside the output globe dividing the inner space of the output globe into a plurality of light scrambling compartments.

2. The LED lighting device of claim 1 further comprising at least one light distribution plate sitting inside the output globe and below the light divider; whereby the light of the LEDs hits either the light divider or the light distribution plate at least one time before exiting the output globe and indirect glare-free surface illumination is achieved.

3. The LED lighting device of claim 1, wherein the output globe is attached to the second end of the heat sink, and the heat sink and the output globe form a standard A19 light bulb shape with an Edison screw as the electrical connector attached to the first end of the heat sink.

4. The LED lighting device of claim 1, wherein the heat sink has a plurality of cutouts at the second end that give the heat sink an octopus-like shape.

5. The LED lighting device of claim 1, wherein the light divider has at least one substantially highly efficient diffusively reflective blade, and is disposed in front of the LEDs, whereby the light divider intercepts and scrambles a substantial amount of the LED light emission.

6. The LED lighting device of claim 1, wherein the heat sink has an inner housing and the LEDs are attached to the interior surface of the heat sink, further comprising a light dome sitting in the inner housing substantially near the second end of the heat sink and above the light divider, and having an interior surface with a substantially high reflectivity that is specular, diffuse, or combination thereof.

7. The LED lighting device of claim 6, wherein the light dome has a tight fit with the output globe, whereby the light scrambling compartments are airtight.

8. The LED lighting device of claim 6, wherein the light dome has a plurality of openings that match the output windows of the LEDs, whereby the LED light emission is guided into the light scrambling compartments.

9. The LED lighting device of claim 8 further comprising a plurality of mirrors with substantially high reflectivity sitting in the openings and surrounding the output windows of the LEDs, whereby a substantial amount of the LED light emission is guided onto the light divider.

10. The LED lighting device of claim 6, wherein the LEDs are the blue LEDs emitting a dominant wavelength in the blue region and the surfaces of the light divider is coated with a plurality of wavelength conversion luminescent phosphor particles, whereby good color reproduction and high luminous efficacy is achieved.

11. The LED lighting device of claim 6, wherein the LEDs are the blue LEDs emitting a dominant wavelength in the blue region and the light divider is made of transparent plastic material embedded with a plurality of wavelength conversion luminescent phosphor particles, whereby good color reproduction and high luminous efficacy is achieved.

12. The LED lighting device of claim 6, wherein the light dome and the light divider are made into one single piece, whereby better manufacturability for reduced cost is achieved.

13. The LED lighting device of claim 1, wherein the output globe is made of substantially transparent plastic material or glass material, or translucent plastic material or glass material, or any combination thereof.

14. The LED lighting device of claim 1, wherein the LEDs further comprise a plurality of first group of semiconductor light emitting diodes (LEDs) with a primary color, and a plurality of second group of semiconductor light emitting diodes (LEDs) with a secondary color, whereby a high color rendering index (CRI) lighting device is achieved.

15. The LED lighting device of claim 2, wherein the light distribution plate has a partial reflectivity that is specular, diffuse, or combination thereof, whereby the light distribution plate enhances omni-directional lighting distribution.

16. The LED lighting device of claim 2, wherein the light distribution plate has a plurality of micro optic elements that have a mixture of specular and diffuse reflection characteristics with partial reflectivity, whereby the light distribution plate enhances omni-directional lighting distribution.

17. An LED lighting device comprising:
an electrical connector;
an electrical AC/DC conversion and control driver;
a heat sink having a first end and a second end;
at least one semiconductor light emitting diode (LED);
an output globe; and
at least one light distribution plate sitting at the bottom inside the output globe.

18. The LED lighting device of claim 17, wherein the light distribution plate has a surface with a partial reflectivity that is specular, diffuse, or combination thereof, whereby the light distribution plate enhances omni-directional lighting distribution.

19. The LED lighting device of claim 17, wherein the light distribution plate has a surface with a plurality of micro optic elements that have a mixture of specular and diffuse reflection characteristics with partial reflectivity, whereby the light distribution plate enhances omni-directional lighting distribution.

20. The LED lighting device of claim 17, wherein the output globe is attached to the second end of the heat sink, and the heat sink and the output globe form a standard A19 light bulb shape with an Edison screw as the electrical connector attached to the first end.

21. The LED lighting device of claim 17, wherein the output globe is made of substantially transparent plastic material or glass material, or translucent plastic material or glass material, or any combination thereof.

22. The LED lighting device of claim 17, wherein the LEDs further comprise a plurality of first group of semiconductor light emitting diodes (LEDs) with a primary color, and a plurality of second group of semiconductor light emitting diodes (LEDs) with a secondary color, whereby a high color rendering index (CRI) lighting device is achieved.
